(19) United States
(12) Patent Application Publication
(10) Pub. No.: US 2009/0234932 A1
(43) Pub. Date: Sep. 17, 2009

(54) COMMUNICATION APPARATUS, METHOD OF CONTROLLING SAME, AND COMMUNICATION SYSTEM

(75) Inventor: Masashi Hamada, Tokyo (JP)

Correspondence Address: COWAN LIEBOWITZ & LATMAN P.C.;JOHN J TORRENTE, 1133 AVE OF THE AMERICAS, NEW YORK, NY, 10036, US

(73) Assignee: CANON KABUSHIKI KAISHA, Tokyo (JP)

(21) Appl. No.: 12/399,085

(22) Filed: Mar. 6, 2009

(30) Foreign Application Priority Data
Mar. 13, 2008 (JP) 2008-064824

(51) Int. Cl. G06F 15/16

(52) U.S. Cl. 709/208

(57) ABSTRACT

A communication apparatus operating by selectively switching between a master mode and a slave mode includes: a determination unit configured to determine whether an apparatus that operates in the master mode exists; a control unit configured to exercise control in such a manner that the communication apparatus operates in the master mode if it is determined that such an apparatus does not exist, and to exercise control in such a manner that the communication apparatus operates in the slave mode if it is determined that such an apparatus does exist; and a transceiver unit configured to transmit a message for updating the management table to the apparatus in the network in case of operation in the master mode, and to receive a message transmitted from another apparatus that operates in the master mode in case of operation in the slave mode.

### BACKGROUND OF THE INVENTION

1. Field of the Invention

The present invention relates to a technique for controlling a master/slave operation in a apparatus having a network management function.

2. Description of the Related Art

Conventionally, a function for centralized control of a network is implemented by being incorporated in a special-purpose device that is constantly connected to the network. For example, a hybrid coordinator function that exercises bandwidth control in compliance with IEEE 802.11e is incorporated in a wireless access point (AP).

The specification of Japanese Patent Laid-Open No. 2006-311139 discloses a method of autonomously changing the operation mode of network management and control within a communication device. More specifically, the application discloses a technique for establishing the operation mode of a wireless terminal having a master/slave mode changeover function through terminal-to-terminal negotiation processing.

There is also a method of connecting a plurality of communication devices which have a control function within a network and sharing various information necessary for control among the plurality of communication devices. For example, the specification of Japanese Patent Laid-Open No. 2006-195890 discloses a technique in which, when shared data possessed by each of the information processing units belonging to the same group is updated, notification of the change is given by broadcast data and an information processing unit that has received such notification queries the update-source information processing unit at a timing of its own and acquires the update information.

Further, the specification of Japanese Patent Laid-Open No. 2007-128165 discloses a technique in which, when a device connected to a network is started up, the device acquires shared information from another device that is operating. When the device that has started up updates the shared information, it notifies the other operating devices of updating of the shared information.

Furthermore, the specification of Japanese Patent Laid-Open No. 2003-216471 discloses a technique in which data-update attribute information (update time, etc.) within an apparatus is exchanged between devices connected to a network and the necessity for updating data within a device is determined by comparing attributes. If updating is determined to be necessary, a terminal that is the source of transmission of an update attribute is requested for the update data.

With the prior art described above, however, a problem arises in a case where each of a plurality of communication devices connected to a local network is equipped with a network management controller, one communication device operates as a master and the other communication devices implement a slave operation. More specifically, when a communication device operating as a master stops operating or leaves the network, it is required that the master commission and control information be delegated to another communication device operating as a slave. Consequently, a problem which arises is that when, for example, there is a sudden disconnect of a wireless communication link, the processing for delegating the master commission cannot be completed.

As a result, a communication device connected to a wired communication path for which there is no risk of sudden disconnect must be equipped with the network management controller that operates as the master. This is an impediment to a flexible arrangement of communication devices in a network.

The present invention has been devised in view of the foregoing problems and seeks to decide master/slave operation and make possible the delegation of a management function through a simple arrangement.

### SUMMARY OF THE INVENTION

According to one aspect of the present invention, a communication apparatus operating by selectively switching between a master mode, in which a management table relating to an apparatus connected to a network is generated and/or updated, and a slave mode, in which a copy of the management table is held, the communication apparatus comprises: a determination unit configured to determine whether an apparatus that operates in the master mode exists in the network; a control unit configured to exercise control in such a manner that the communication apparatus operates in the master mode if it is determined by the determination unit that an apparatus that operates in the master mode does not exist, and to exercise control in such a manner that the communication apparatus operates in the slave mode if it is determined by the determination unit that an apparatus that operates in the master mode does exist; and a transceiver unit configured to transmit a message for updating the management table to the apparatus in the network in case of operation in the master mode, and to receive a message transmitted from another apparatus that operates in the master mode in case of operation in the slave mode.

According to another aspect of the present invention, a method of controlling a communication apparatus by selectively switching between a master mode, in which a management table relating to an apparatus connected to a network is generated and/or updated, and a slave mode, in which a copy of the management table is held, the method comprises: a determination step of determining whether an apparatus that operates in the master mode exists in the network; a control step of exercising control in such a manner that the communication apparatus operates in the master mode if it is determined at the determination step that an apparatus that operates in the master mode does not exist, and exercising control in such a manner that the communication apparatus operates in the slave mode if it is determined at the determination step that an apparatus that operates in the master mode does exist; and a transceiver step of transmitting a message for updating the management table to the apparatus in the network in case of operation in the master mode, and receiving a message transmitted from another apparatus that operates in the master mode in case of operation in the slave mode.

In accordance with the present invention, a technique for deciding master/slave operation and enabling the delegation of a management function through a simple arrangement can be provided.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a diagram illustrating a network configuration according to a first embodiment of the present invention;

FIG. 2 is a diagram (pattern 1) illustrating a processing sequence involving devices in a communication system according to the first embodiment;

FIG. 3 is a diagram (pattern 2) illustrating the network configuration according to the first embodiment;

FIG. 4 is a diagram (pattern 2) illustrating a processing sequence involving devices in the communication system according to the first embodiment;

FIG. 5 is a diagram (pattern 4) illustrating a network configuration according to a second embodiment of the present invention;

FIG. 6 is a diagram (pattern 4) illustrating a processing sequence involving devices in the communication system according to the second embodiment;

FIG. 7 is a diagram (pattern 5) illustrating the network configuration according to the second embodiment;

FIG. 8 is a diagram (pattern 5) illustrating a processing sequence involving devices in the communication system according to the second embodiment;

FIG. 9 is a diagram (pattern 3) illustrating the network configuration according to the first embodiment;

FIG. 10 is a diagram (pattern 3) illustrating a processing sequence involving devices in the communication system according to the first embodiment;

FIG. 11 is a flowchart of operation when an MWC function unit is started up;

FIG. 12 is an operation flowchart of a master MWC search executed periodically by an MWC function unit that operates in a slave mode;

FIG. 13 is a flowchart of operation when an MWC function unit that operates in a slave mode has received a request to set a traffic-stream channel;

FIG. 14 is a flowchart of operation when a DSC has received a request to set a traffic-stream channel;

FIG. 15 is a diagram (pattern 6) illustrating a network configuration according to a third embodiment of the present invention; and

FIG. 16 is a diagram (pattern 6) illustrating a processing sequence involving devices in the communication system according to the third embodiment.

### DESCRIPTION OF THE EMBODIMENTS

Preferred embodiments of the present invention will now be described in detail with reference to the accompanying drawings. It should be noted that the structural elements described in these embodiments are exemplary and that the scope of the present invention is not limited solely to these structural elements.

### First Embodiment

A first embodiment of a communication system according to the present invention will now be described taking as an example a communication system that includes a communication device having a wireless-LAN bandwidth management function.

<Overview>

In the first embodiment, a single server apparatus and two display devices connected to a wired network are each equipped with a multimedia wireless controller (MWC) for implementing a bandwidth management function at an access point (AP). Assume that in an initial state, the MWC function unit of the server apparatus is operating as a master. Operation of the MWC function unit in each of the other devices when this server apparatus stops operating and when operation thereof is restored will be described.

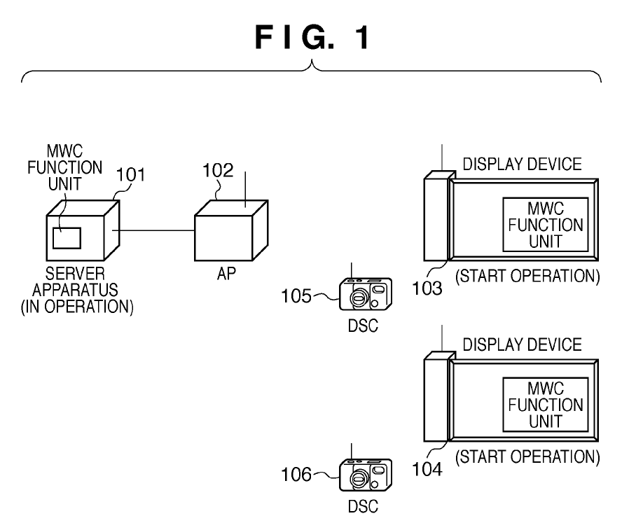

FIG. 1 is a diagram illustrating the network configuration according to the first embodiment.

A local network system comprises a wireless LAN, which is formed by a wireless access point (AP) 102, and a wired LAN. A server apparatus 101 is connected to the wired LAN, and display devices 103, 104 and digital still cameras (DSCs) 105, 106 are connected to the wireless LAN. The server apparatus 101 and the display devices 103, 104 each are equipped with a MWC function unit for implementing a bandwidth management function at the AP 102.

More specifically, the MWC function unit manages the remaining amount of communication resources (communication bandwidth, communication priority, etc.) of the network and, based upon a self-generated management table, grants a suitable bandwidth and designates a communication path in response to a traffic-stream (TS) setting request from each device.

Furthermore, the MWC function unit is adapted so as to operate by selectively switching between a master mode, in which a management table relating to one or more devices connected to the network is generated and/or updated autonomously, and a slave mode for holding a copy of the management table generated and/or updated in the master mode. It should be noted that in the local network system, there is only one MWC function unit that operates in the master mode. In other words, the other MWC function units all operate in the slave mode.

<System Operation>

Operation in the following three patterns will be described successively:

Pattern 1: operation of each MWC function unit in a case where the display devices 103 and 104 are started up while the MWC function unit of the server apparatus 101 is operating in the master mode;

Pattern 2: operation of each MWC function unit in a case where the MWC function unit of the server apparatus 101 stops operating; and

Pattern 3: operation of each MWC function unit in a case where the MWC function unit of the server apparatus 101 is restored to normal operation.

Also described will be a setting request operation for setting a traffic-stream channel in each of these cases.

[Pattern 1]

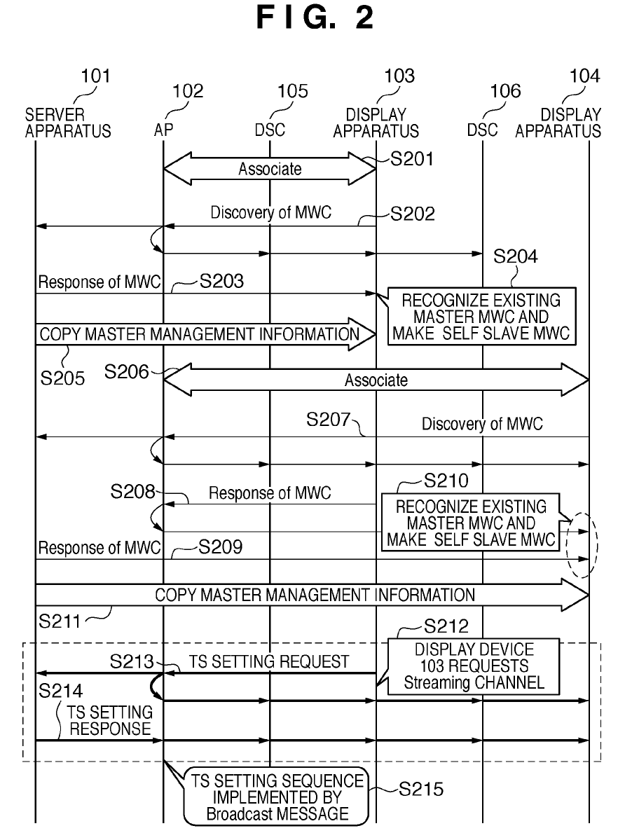

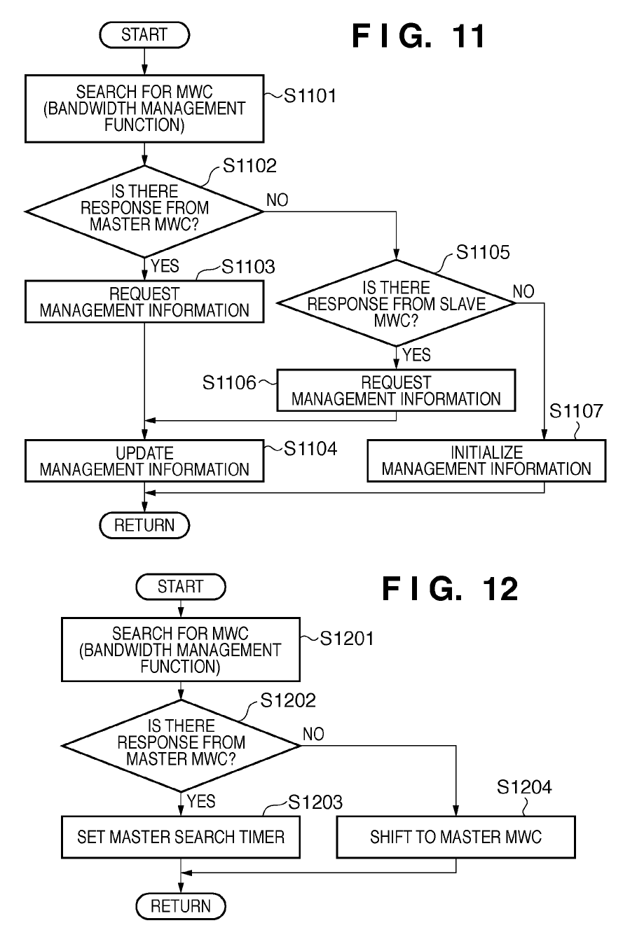

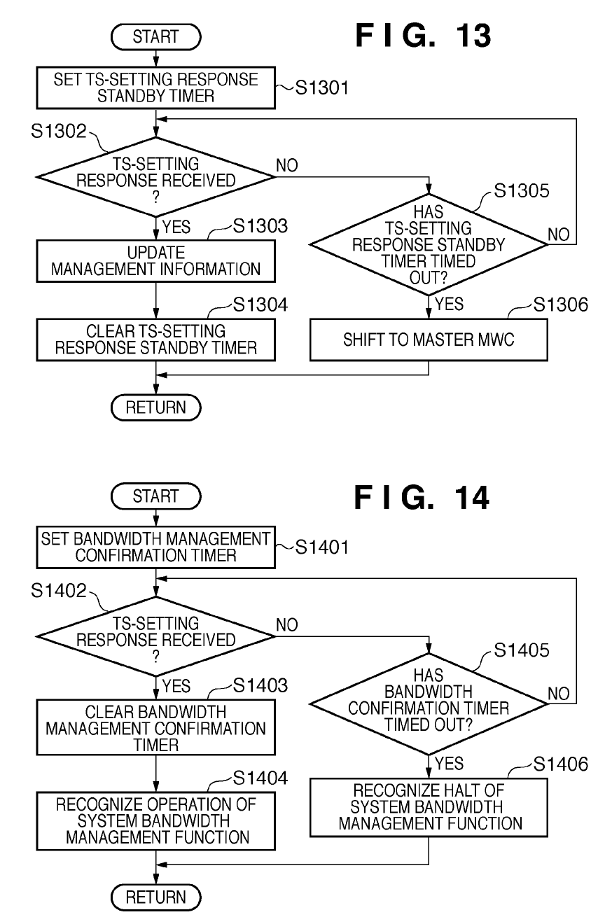

FIG. 2 is a diagram (pattern 1) illustrating a processing sequence involving the devices in the communication system according to the first embodiment. Further, FIG. 11 is a flowchart of operation when an MWC function unit is started up, and FIG. 13 is a flowchart of operation when an MWC function unit that operates in a slave mode has received a request to set a traffic-stream channel.

In step S201 in FIG. 2, the display device 103 and the AP 102 are connected (associated).

In step S202, using a broadcast packet, the display device 103 transmits a probe message in order to determine whether a currently operating MWC function unit already exists on the network following the association with the access point (step S1101 in FIG. 11). The broadcast packet is a packet in which a broadcast address or multicast address is set as the destination address of the packet, and is capable of being received by a plurality of devices.

In step S203, upon receiving the probe message, the server apparatus 101, which has the MWC function unit already operating on the network in the master mode, sends back a response message to the display device 103 that was the source of the transmission.

In step S204, upon receiving the response message (step S1102) from the server apparatus 101, the display device 103 recognizes the existence of the MWC function unit already operating in the master mode and causes its own MWC function unit to operate in the slave mode.

In step S205, the display device 103 requests the MWC function unit (step S1103) operating in the master mode (here the server apparatus 101) for management information needed for control necessary in order to grant the bandwidth and designate the communication path. The display device 103 copies the management table of the master MWC function unit.

In step S206, the display device 104 and the AP 102 are associated. Operation from this point onward is substantially similar to that in the case of display device 103.

In step S207, using a broadcast packet, the display device 104 transmits a probe message in order to determine whether a currently operating MWC function unit already exists on the network following the association with the access point (step S1101).

In step S208, upon receiving the probe message, the display device 103, which has the MWC function unit already operating on the network in the slave mode, sends back a response message to the display device 104 that was the source of the transmission.

In step S209, upon receiving the probe message, the server apparatus 101, which has the MWC function unit already operating on the network in the master mode, sends back a response message to the display device 104 that was the source of the transmission.

In step S210, upon receiving the response message (step S1102) from the server apparatus 101, the display device 104 recognizes the existence of the MWC function unit already operating in the master mode and causes its own MWC function unit to operate in the slave mode.

In step S211, the display device 104 requests the MWC function unit (step S1103) operating in the master mode (here the server apparatus 101) for management information needed for control necessary in order to grant the bandwidth and designate the communication path. The display device 104 copies the management table of the master MWC function unit.

In step S212, the display device 103 requests setting of a traffic-stream channel. At this time the display device 103 uses a broadcast packet to implement a message sequence (steps S213 to S215 and steps S1301 to S1304) for setting a traffic-stream channel. In other words, the display devices 103 and 104 belonging to the same network receive a control message (step S3102 in FIG. 13) that employs a broadcast packet for setting a traffic-stream channel. Specifically, a control message for updating the management table is broadcast. The MWC function units of the display devices 103 and 104 therefore are capable of updating (step S1303) the management table, which was copied in steps S205 and S211, based upon the content of the control message. That is, it is possible to update the table to content the same as the content updated in the management table held by the MWC function unit that operates in the master mode.

By virtue of the above-described processing, in a case where the display devices 103 and 104 are started up, each of the MWC function units operates in the slave mode and therefore the MWC function unit that operates in the master mode in the network is only that within the server apparatus 101. Furthermore, after the initial management table is copied, the display devices 103 and 104 are capable of synchronizing the management tables without communicating individually with the MWC function unit that operates in the master mode.

[Pattern 2]

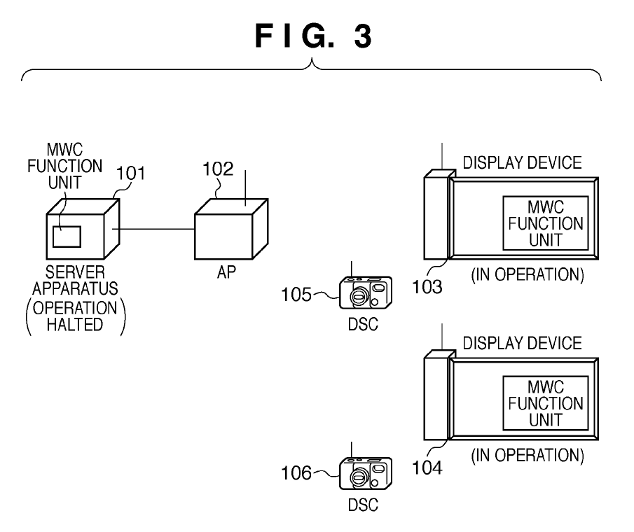

FIG. 3 is a diagram (pattern 2) illustrating the network configuration according to the first embodiment. In other words, FIG. 3 illustrates a case where the MWC function unit of the server apparatus 101 has stopped operating when the state of FIG. 1 is in effect.

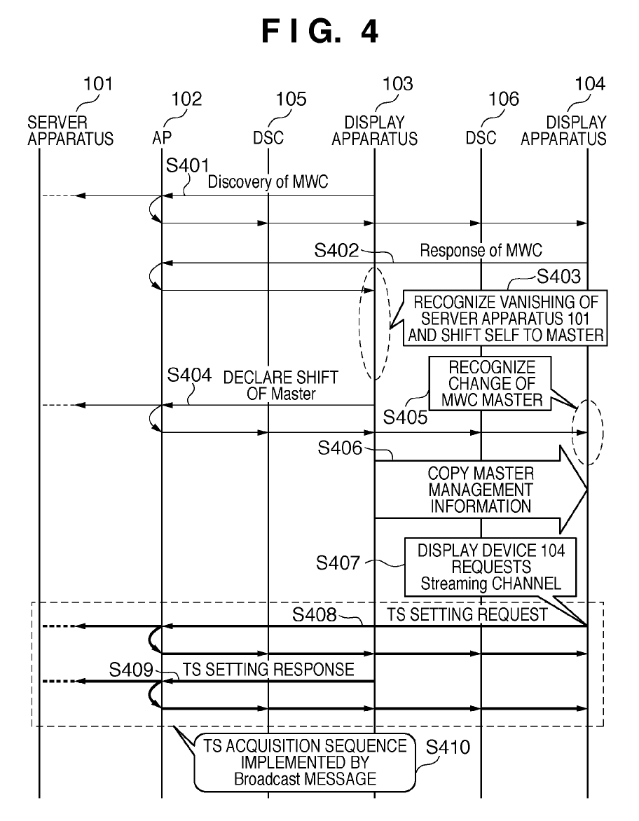

FIG. 4 is a diagram (pattern 2) illustrating a processing sequence involving the devices in the communication system according to the first embodiment. FIG. 12 is an operation flowchart of a master MWC search executed periodically by an MWC function unit that operates in the slave mode.

In step S401, using a broadcast packet, the display device 103 transmits a probe message at a predesignated period in order to determine whether a currently operating MWC function unit exists on the network (step S1201 in FIG. 12). In other words, verification of a MWC function unit operating on the network is performed automatically if a preset period of time has elapsed.

In step S402, only the display device 104 currently operating receives the probe message and sends back a response message to the display device 103 that was the source of the transmission. In other words, since the server apparatus 101 has stopped operating, it does not send back a response message.

In step S403, since the display device 103 cannot receive a response message from the server apparatus 101 (“NO” in step S1202), the display device 103 recognizes that the MWC function unit operating in the master mode has vanished.

In step S404, based on recognition of the fact that the MWC function unit operating in the master mode has vanished, the display device 103 decides that its own MWC function unit will operate in the master mode (step S1204). Then, before operation in the master mode starts, the display device 103 uses a broadcast message to declare to each device in the network the fact that it has started (shifted to) operation in the master mode. It should be noted that the latest management table that was retained in the case where the unit was operating in the slave mode continues to be utilized.

In step S405, the display device 104, which has received the broadcast message transmitted in step S404, recognizes a change in the device of the MWC function unit that operates in the master mode.

In step S406, the display device 104 requests the MWC function unit operating in the master mode (here the display device 103) for management information needed for control necessary in order to grant the bandwidth and designate the communication path. The display device 104 copies the management table of the master MWC function unit.

In step S407, the display device 104 requests setting of a traffic-stream channel. At this time the display device 104 uses a broadcast packet to implement a message sequence (steps S408 to S410 and steps S1301 to S1304) for setting a traffic-stream channel. In other words, the display device 104 belonging to the same network receives a control message (step S3102) that employs a broadcast packet for setting a traffic-stream channel. The MWC function unit of the display device 104 therefore is capable of updating (step S1303) the management table, which was copied in step S406, based upon the content of the control message. That is, it is possible to update the table to content the same as the content updated in the management table held by the MWC function unit that operates in the master mode.

By virtue of the above-described processing, the MWC function unit of the display device 103 comes to operate in the master mode even in a case where the server apparatus 101 having the MWC function unit that operates in the master mode stops operating. Further, the MWC function unit that operates in the network in the master mode is solely that within the display device 103. Furthermore, after the initial management table is copied, the display device 104 is capable of synchronizing the management table without communicating individually with the MWC function unit that operates in the master mode. It should be noted that whether or not a MWC function unit that operates in the master mode exists is determined by the probe message. However, it may be so arranged that in a case where the control message is not received in a preset period of time, a decision is rendered to the effect that there is no MWC function unit that operates in the master mode.

In other words, it is possible to change the MWC function unit that operates in the master mode without requiring the execution of negotiation processing. As a result, even in the event that the MWC function unit that operates in the master mode leaves the network or stops operating owing to interruption of power, etc., it is possible for the management function to continue being implemented.

[Pattern 3]

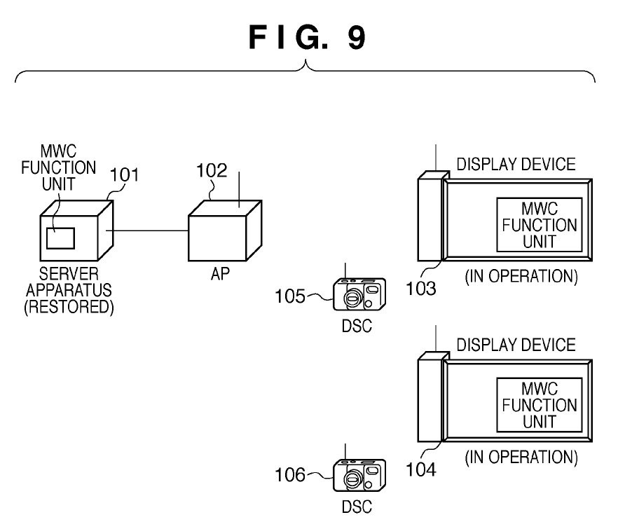

FIG. 9 is a diagram (pattern 3) illustrating the network configuration according to the first embodiment. In other words, FIG. 9 illustrates a case where the MWC function unit of the server apparatus 101 is restored from the state shown in FIG. 3.

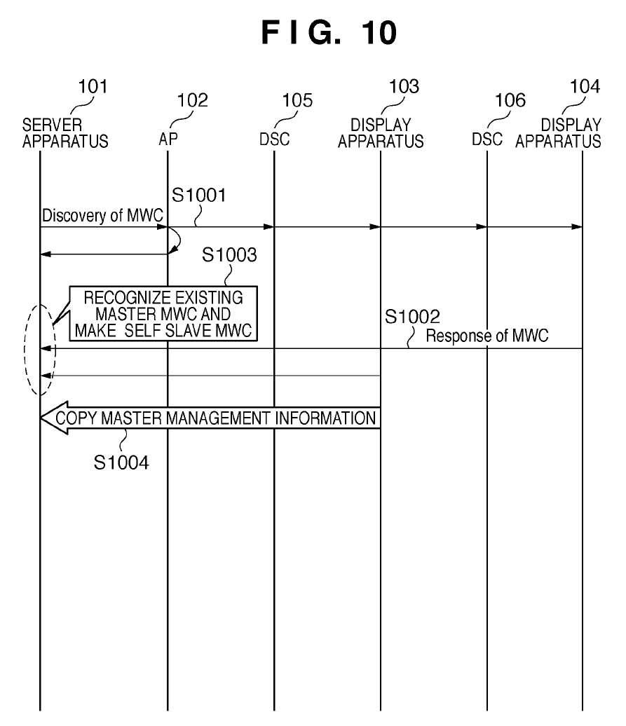

FIG. 10 is a diagram (pattern 3) illustrating a processing sequence involving the devices in the communication system according to the first embodiment.

In step S1001, using a broadcast packet, the server apparatus 101 that has been restored to the local network transmits a probe message in order to determine whether a currently operating MWC function unit exists on the network (step S1101).

In step S1002, when the display device 103, which has the MWC function unit already operating on the network in the master mode, receives the probe message, it sends back a response message to the server apparatus 101 that was the source of the transmission. Further, when the display device 104, which has the MWC function unit already operating on the network in the slave mode, receives the probe message, it sends back a response message to the server apparatus 101 that was the source of the transmission.

In step S1003, the server apparatus 101, which has received the response message from the display device 103 (“YES” in step S1102), recognizes the existence of the MWC function unit already operating in the master mode. The server apparatus 101 then causes its own MWC function unit to operate in the slave mode.

In step S1004, the server apparatus 101 requests the MWC function unit operating in the master mode (here the display device 103) for management information needed for control necessary in order to grant the bandwidth and designate the communication path. The server apparatus 101 copies the management table of the master MWC function unit.

By virtue of the above-described processing, the MWC function unit of the display device 103 continues operating in the master mode even in a case where the halted server apparatus 101 is restored to operation. Further, the MWC function unit that operates in the network in the master mode is solely that within the display device 103. Furthermore, after the initial management table is copied, the server apparatus 101 is capable of synchronizing the management table without communicating individually with the MWC function unit that operates in the master mode.

Thus, in accordance with the communication system of the first embodiment, as described above, it is possible to decide master/slave operation and delegate a management function through a simple arrangement. Further, by utilizing a broadcast packet in a control message, an MWC function unit that operates in the slave mode can synchronize the management table without communicating individually with an MWC function unit that operates in the master mode.

### Second Embodiment

<Overview>

In a second embodiment, operation in a case where some devices form a new network and leave an existing network will be described. It should be noted that the configuration of the system in the initial state is similar to the configuration of FIG. 1 in the first embodiment and therefore the details thereof need not be described again. The state described here will be the state in effect when the processing of FIG. 10 ends.

In other words, it will be assumed here that among the MWC function units at AP 102 in the server apparatus 101 and display devices 103, 104, the MWC function unit operating in the master mode is that of the display device 103.

<System Operation>

Operation in the following two patterns will be described successively:

Pattern 4: operation of each MWC function unit in a case where the display device 103 leaves the network while the MWC function unit thereof is operating in the master mode; and

Pattern 5: operation of each MWC function unit in a case where the display device 103 has returned to the network.

Also described will be a setting request operation for setting a traffic-stream channel in each of these cases.

[Pattern 4]

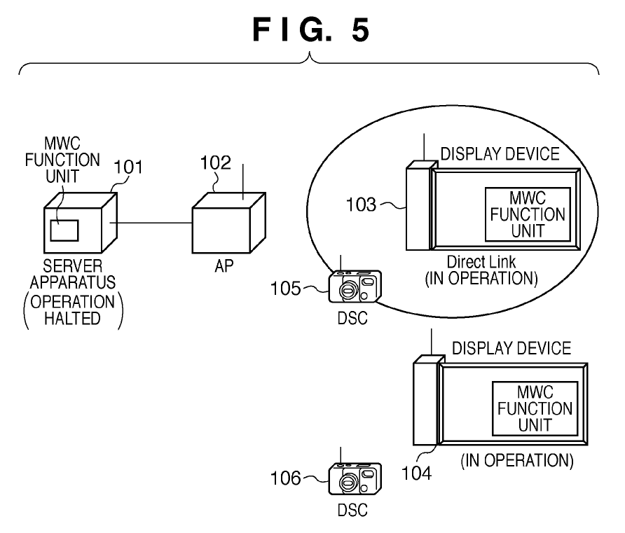

FIG. 5 is a diagram (pattern 4) illustrating a network configuration according to the second embodiment. In other words, FIG. 5 illustrates a case where the display device 103 has left the network from the state shown in FIG. 9.

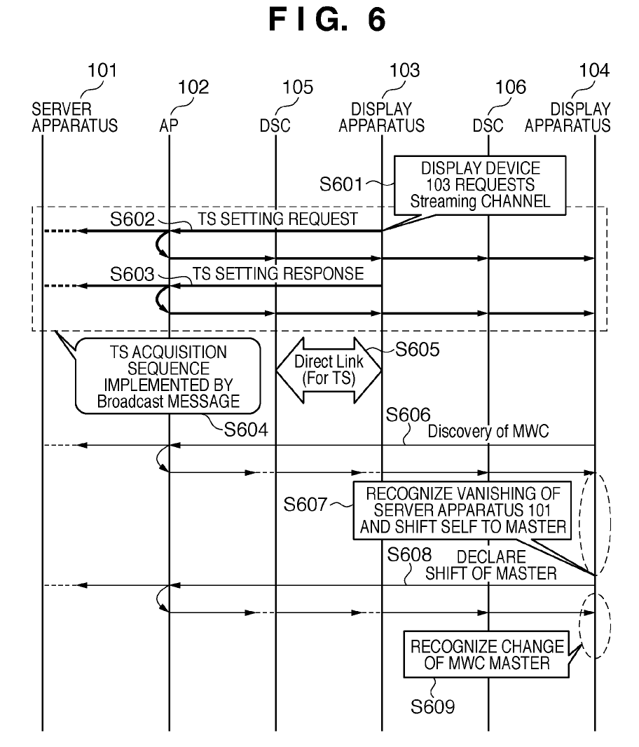

FIG. 6 is a diagram (pattern 4) illustrating a processing sequence involving the devices in the communication system according to the second embodiment.

In step S601, the display device 103 requests the setting of a traffic-stream channel between itself and the DSC 105. At this time the display device 103 uses a broadcast packet to implement a message sequence (steps S602 to S604 and steps S1301 to S1304) for setting a traffic-stream channel. The MWC function unit of the display device 104 therefore is capable of updating (step S1303) the management table based upon the content of the control message.

In step S605, the display device 103 and DSC 105 shift to a wireless direct-link connection, leave the local network and form an independent network. In other words, the MWC function unit that operates in the master mode vanishes from the local network owing to the forming of the wireless direct link.

In step S606, using a broadcast packet, the display device 104 transmits a probe message at a predesignated period in order to determine whether a currently operating MWC function unit exists on the network (step S1201).

In step S607, the display device 104 cannot receive a response message from the display device 103 and therefore recognizes that the MWC function unit operating in the master mode has vanished (step S1202). The reason for this is that only the currently operating server apparatus 101 receives the probe message and sends back a response message to the display device 104 that was the source of the transmission. Since the display device 103 has left the network, it does not send back a response message.

In step S608, the display device 104 decides that its own MWC function unit is to operate in the master mode based upon recognition of the fact that the MWC function unit operating in the master mode has vanished from the network (step S1204). The display device 103 then uses a broadcast message to declare to each device in the network the fact that it has shifted to operation in the master mode (step S609).

By virtue of the processing described above, the MWC function unit of the display device 104 comes to operate in the master mode even in a case where the display device 103 having the MWC function unit that operates in the master mode has left the network. Further, the MWC function unit that operates in the network in the master mode is solely that within the display device 104.

[Pattern 5]

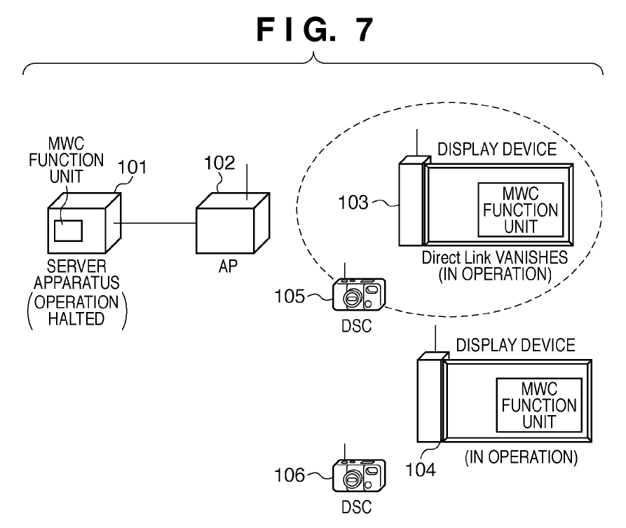

FIG. 7 is a diagram (pattern 5) illustrating a network configuration according to the second embodiment. In other words, FIG. 7 illustrates a case where the display device 103 has returned to the local network from the state shown in FIG. 5.

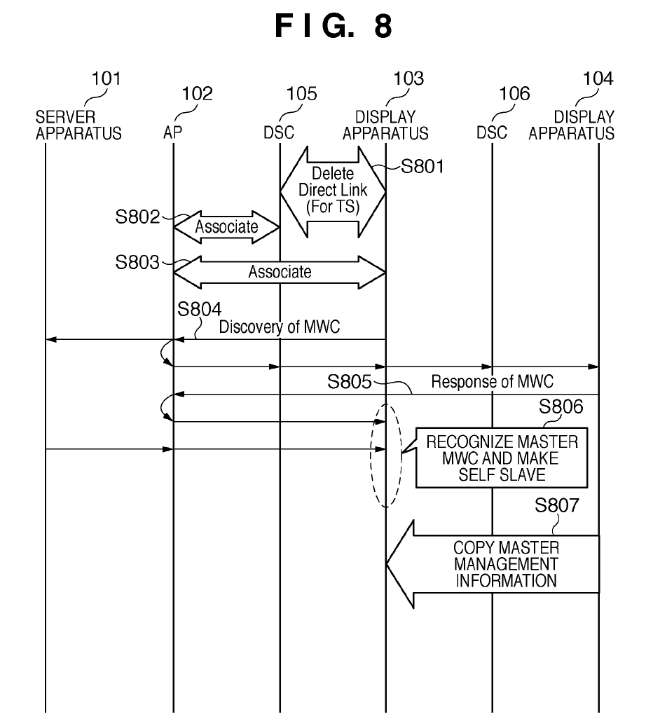

FIG. 8 is a diagram (pattern 5) illustrating a processing sequence involving the devices in the communication system according to the second embodiment.

In step S801, the display device 103 and DSC 105 cancel the direct link of the wireless link. These then cancel the independent network and return to the local network (steps S802, S803).

In step S804, the display device 103 that has returned to the local network transmits a probe message using a broadcast packet in order to determine whether a currently operating MWC function unit exists on the network (step S1101).

In step S805, when it has received the probe message, the display device 104 having the MWC function unit already operating in the network in the master mode sends back a response message to the display device 103, which was the source of the transmission. Further, when has received the probe message, the server apparatus 101 having the MWC function unit already operating in the network in the slave mode sends back a response message to the display device 103, which was the source of the transmission.

In step S806, the display device 103, which has received the response message from the display device 104 (step S1102), recognizes the existence of the MWC function unit already operating in the master mode. The display device 103 then causes its own MWC function unit to operate in the slave mode.

In step A807, the display device 103 requests the MWC function unit operating in the master mode (here the display device 104) for management information needed for control necessary in order to grant the bandwidth and designate the communication path.

By virtue of the processing described above, the MWC function unit of the display device 104 continues operating in the master mode even in a case where the display device 103 that has left the local network is restored to the network. Further, the MWC function unit that operates in the network in the master mode is solely that within the display device 104.

Thus, in accordance with the communication system of the second embodiment, as described above, it is possible to decide master/slave operation and delegate a management function through a simple arrangement. Further, by utilizing a broadcast packet in a control message, an MWC function unit that operates in the slave mode can synchronize the management table without communicating individually with an MWC function unit that operates in the master mode.

### Third Embodiment

<Overview>

In a third embodiment, another operation in a case where some devices form a new network and leave an existing network will be described. It should be noted that the configuration of the system in the initial state is similar to the configuration of FIG. 1 in the first embodiment and therefore the details thereof need not be described again. The state described here will be the state in effect when the processing of FIG. 10 ends.

In other words, it will be assumed here that among the MWC function units at AP 102 in the server apparatus 101 and display devices 103, 104, the MWC function unit operating in the master mode is that of the display device 103.

<System Operation>

Operation in the following pattern will be described:

Pattern 6: operation of each MWC function unit in a case where the display device 103 leaves the network while the MWC function unit thereof is operating in the master mode.

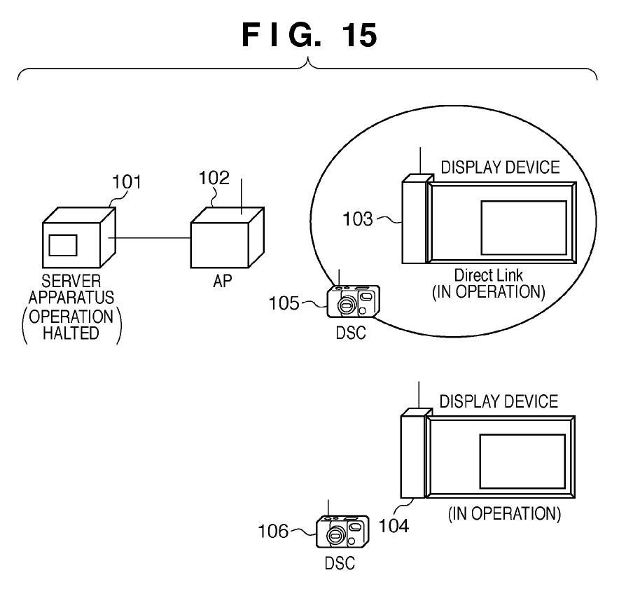

FIG. 15 is a diagram (pattern 6) illustrating a network configuration according to the third embodiment. In other words, FIG. 15 illustrates a case where the display device 103 has left the network from the state shown in FIG. 9.

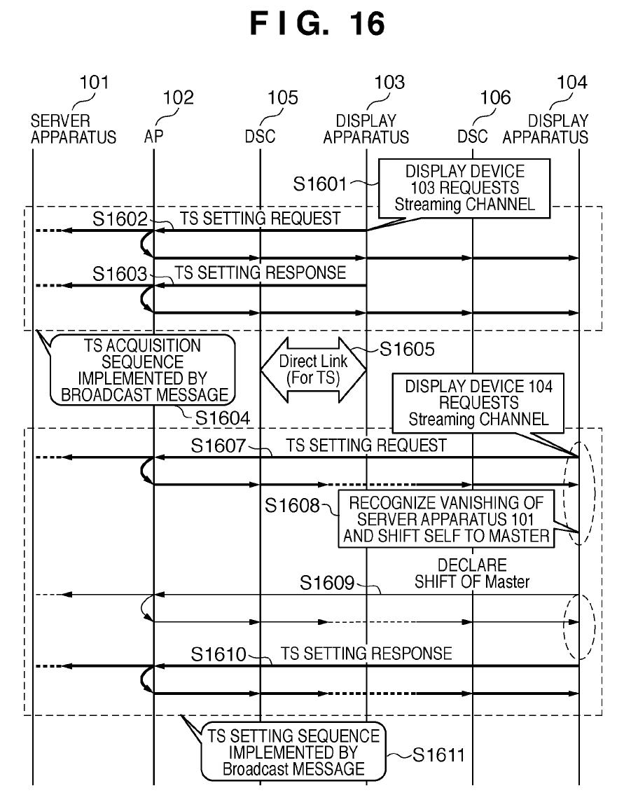

FIG. 16 is a diagram (pattern 6) illustrating a processing sequence involving the devices in the communication system according to the third embodiment.

In step S1601, the display device 103 requests the setting of a traffic-stream channel between itself and the DSC 105. At this time the display device 103 uses a broadcast packet to implement a message sequence (steps S1602 to S1604 and steps S1301 to S1304) for setting a traffic-stream channel. The MWC function unit of the display device 104 therefore is capable of updating (step S1303) the management table based upon the content of the control message.

In step S1605, the display device 103 and DSC 105 shift to a wireless direct-link connection, leave the local network and form an independent network. In other words, the MWC function unit that operates in the master mode vanishes from the local network owing to the forming of the wireless direct link.

In step S1606, the display device 104 requests the setting of a traffic-stream channel. At this time, following the transmission (step S1607) of a message requesting the setting of the traffic-stream channel, the display device 104 sets a response-standby timer for waiting for a prescribed period of time (step S1301). At this point in time, however, the MWC function unit operating in the master mode has vanished from the local network and therefore a response message corresponding to the channel setting request is not transmitted. As a consequence, the response-wait timer times out without receipt of a response message (steps S1302, S1305). As a result, the display device 104, which requested the setting of the channel, recognizes the fact that an MWC function unit that operates on the master network in the master mode is inactive.

In step S1608, the display device 104 decides that its own MWC function unit is to operate in the master mode based upon recognition of the fact that an MWC function unit operating in the master mode has vanished. The display device 104 then sends back a response message, which corresponds to transmission (step S1607) of the channel setting request message sent earlier, as a message using a broadcast packet (step S1610). This completes a message sequence (steps S1607, S1610, S1611) for setting the traffic-stream channel using the broadcast packet.

In step S1609, the display device 104 uses a broadcast message to declare to each device in the network the fact that it has shifted to operation in the master mode (step S609).

In other words, the fact that the MWC function unit that operates in the master mode has vanished can be verified based upon whether or not a setting-response message corresponding to the message requesting the setting of a traffic-stream channel has been received. Naturally, it is also permissible to make joint use of transmission of a probe message at a pre-designated period described in the first and second embodiments.

### Fourth Embodiment

Described in a fourth embodiment is a method in which DSCs 105 and 106 connected to the local network using a wireless LAN and not equipped with an MWC function unit detect vanishing of a master MWC function unit.

FIG. 14 is a flowchart of operation when a DSC has received a request to set a traffic-stream channel.

In step S1401, a digital camera, upon receiving a traffic-stream channel request message using a broadcast packet, sets a timer for verifying receipt of a response message corresponding to the message requesting the setting of a channel.

In steps S1402 and S1405, the camera determines whether a response message corresponding to the message requesting the setting of the channel has been sent back within the prescribed period of time. If this could be confirmed, control proceeds to step S1403; otherwise, control proceeds to step S1406.

In step S1403, the DSC clears the timer and recognizes operation of the MWC function unit that operates in the master mode (S1404).

In step S1406, the DSC recognizes that an MWC function unit that operates in the master mode is not operating.

By virtue of the processing described above, even a device not having an MWC function unit can check whether an MWC function unit is operating or not.

### Other Embodiments

Although embodiments of the present invention have been described above, the present invention may be applied to a system constituted by a plurality of devices or to an apparatus comprising a single device.

Furthermore, the object of the invention is attained also by supplying a program, which implements the functions of the foregoing embodiments, directly or remotely to a system or apparatus, reading the supplied program codes by the system or apparatus, and then executing the program codes. Accordingly, since the functional processing of the present invention is implemented by computer, the program code per se installed on the computer falls within the technical scope of the present invention.

In this case, so long as the system or apparatus has the functions of the program, the form of the program, for example, object code, a program executed by an interpreter or script data supplied to an operating system, etc., does not matter.

Examples of recording media that can be used for supplying the program are a floppy (registered trademark) disk, hard disk, optical disk (CD, DVD), magneto-optical disk, magnetic tape, non-volatile type memory card and ROM, etc.

Further, the functions of the above-described embodiments can be implemented by having a computer execute a program that has been read. In addition, an operating system or the like running on a computer can perform some or all of the actual processing based upon the instructions of the program so that the functions of the foregoing embodiments can be implemented by this processing.

Furthermore, a program read from the recording medium can be written to a memory provided on a function expansion board inserted into the computer or provided in a function expansion unit connected to the computer. Thereafter, a CPU or the like mounted on the function expansion board or function expansion unit can perform some or all of the actual processing so that the functions of the foregoing embodiments can be implemented by this processing.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-064824, filed Mar. 13, 2008, which is hereby incorporated by reference herein in its entirety.

What is claimed is:

1. A communication apparatus operating by selectively switching between a master mode, in which a management table relating to an apparatus connected to a network is generated and/or updated, and a slave mode, in which a copy of the management table is held, the communication apparatus comprising:
a determination unit configured to determine whether an apparatus that operates in the master mode exists in the network;
a control unit configured to exercise control in such a manner that the communication apparatus operates in the master mode if it is determined by the determination unit that an apparatus that operates in the master mode does not exist, and to exercise control in such a manner that the communication apparatus operates in the slave mode if it is determined by the determination unit that an apparatus that operates in the master mode does exist; and
a transceiver unit configured to transmit a message for updating the management table to the apparatus in the network in case of operation in the master mode, and to receive a message transmitted from another apparatus that operates in the master mode in case of operation in the slave mode.

2. The apparatus according to claim 1, wherein in a case where the communication apparatus is operating in the slave mode and a preset period of time elapses, the control unit exercises control in such a manner that the communication apparatus operates in the master mode if whether or not an apparatus that operates in the master mode exists in the network is determined by the determination unit and it is determined that an apparatus that operates in the master mode does not exist.

3. The apparatus according to claim 1, wherein in a case where the communication apparatus is operating in the slave mode and a message is not received by the transceiver unit in a preset period of time, the control unit exercises control in such a manner that the communication apparatus operates in the master mode.

4. The apparatus according to claim 1, wherein before operation starts in the master mode, the transceiver unit transmits a message indicating that operation in the master mode will start.

5. The apparatus according to claim 1, wherein in a case where the mode shifts from the slave mode to the master mode, the control unit starts operation in the master mode using the latest management table that was being held in the slave mode.

6. The apparatus according to claim 1, wherein the management table is a table that manages a communication bandwidth allocated to each apparatus connected to the network.

7. The apparatus according to claim 1, wherein the management table is a table that manages a communication priority assigned to each apparatus connected to the network.

8. A method of controlling a communication apparatus by selectively switching between a master mode, in which a management table relating to an apparatus connected to a network is generated and/or updated, and a slave mode, in which a copy of the management table is held, the method comprising:
a determination step of determining whether an apparatus that operates in the master mode exists in the network;
a control step of exercising control in such a manner that the communication apparatus operates in the master mode if it is determined at the determination step that an apparatus that operates in the master mode does not exist, and exercising control in such a manner that the communication apparatus operates in the slave mode if it is determined at the determination step that an apparatus that operates in the master mode does exist; and
a transceiver step of transmitting a message for updating the management table to the apparatus in the network in case of operation in the master mode, and receiving a message transmitted from another apparatus that operates in the master mode in case of operation in the slave mode.

9. A program for causing a computer to function as each unit of the communication apparatus set forth in claim 1.

10. A communication system that includes at least two of the communication apparatus set forth in claim 1.
